(19) United States
(12) Patent Application Publication
(10) Pub. No.: US 2010/0130030 A1
(43) Pub. Date: May 27, 2010

(54) IC SOCKET HAVING AN IMPROVED LOCKING ARRANGEMENT AND METHOD OF MAKING THE SAME

(75) Inventors: FANG-JWU LIAO, Tu-Cheng (TW); CHENG-CHI YEH, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/463,425

(22) Filed: May 11, 2009

(30) Foreign Application Priority Data
Nov. 25, 2008 (TW) 97221047

(51) Int. Cl. H01R 12/00; H01R 43/16

(52) U.S. Cl. 439/68; 29/874

(57) ABSTRACT

An IC socket (1) mounted on a printed circuit board (9) for receiving an IC package (10) includes a socket body (2), a plurality of contacts (3) received in the socket body (2), a stiffener plate (4) surrounding the socket body (2), and a locking arrangement (7) securing the stiffener plate (4) to the printed circuit board (9). The locking arrangement (9) includes a ferrule (70) fixed on the stiffener plate (4) and a screw (71) disposed within the ferrule (70) before the stiffener plate (4) mounted onto the printed circuit board (9).

### FIELD OF THE INVENTION

The present invention relates to an IC socket, and more particularly to IC socket having an improved locking arrangement capable of simplifying the process of mounting the IC socket to a printed circuit board (PCB).

### DESCRIPTION OF PRIOR ART

IC sockets are widely used in the computer field to interconnect two separate electronic components, i.e. an IC package and a motherboard, so as to establish electrical connection therebetween. U.S. Pat. No. 7,404,728 issued to Ma on Jul. 29, 2008 discloses an IC socket that includes an insulative housing, a plurality of contacts received in the housing, a stiffener plate surrounding the housing and a load plate pivotally coupled to the stiffener plate for loading an IC package into the housing. The stiffener plate is fixed to a PCB by four screws respectively located at four corners thereof. The screws are separate from the stiffener plate before the socket is mounted to the PCB. When the socket is mounted to the PCB, the stiffener plate is firstly disposed to a predetermined position on the PCB, and then the screws are inserted into corresponding mounting holes of the stiffener plate and the PCB so as to stably fix the stiffener plate on the PCB. However, such an assembling process is complicated and thereby decreases efficiency of mounting the socket to PCB.

Thus, there is a need to provide a new IC socket that overcomes the above-mentioned problems.

### SUMMARY OF THE INVENTION

It is therefore the object of the present invention to provide an IC socket having an improved locking arrangement that is inseparably combined into a stiffener plate of the IC socket.

In accordance with the present invention, an IC socket mounted on a printed circuit board for receiving an IC package includes a socket body, a plurality of contacts received in the socket body, a stiffener plate surrounding the socket body, and a locking arrangement securing the stiffener plate to the printed circuit board. The locking arrangement includes a ferrule fixed on the stiffener plate and a screw and a screw disposed within the ferrule before the stiffener plated mounted onto the printed circuit board.

### BRIEF DESCRIPTION OF THE DRAWINGS

Other objects, advantages and novel features of the present invention will become more apparent from the following detailed description when taken in conjunction with the accompanying drawings, in which:

FIG. 1 is an assembled, perspective view of an IC socket in accordance with a preferred embodiment of the present invention mounted on a printed circuit board, and an IC package is received in the IC socket;

FIG. 2 is an exploded, perspective view of FIG. 1;

FIG. 3 is an exploded, perspective view of a locking arrangement of the IC socket in accordance with the preferred embodiment of the present invention;

FIG. 4 is a perspective view of a ferrule of the IC socket in accordance with the preferred embodiment of the present invention;

FIG. 5 is a perspective view of a stiffener plate of the IC socket in accordance with the preferred embodiment of the present invention, wherein the locking arrangement is combined with the stiffener plate; and

FIG. 6 is a cross-sectional view of the socket fixed on the printed circuit board by the locking arrangement.

### DETAILED DESCRIPTION OF PREFERRED EMBODIMENT

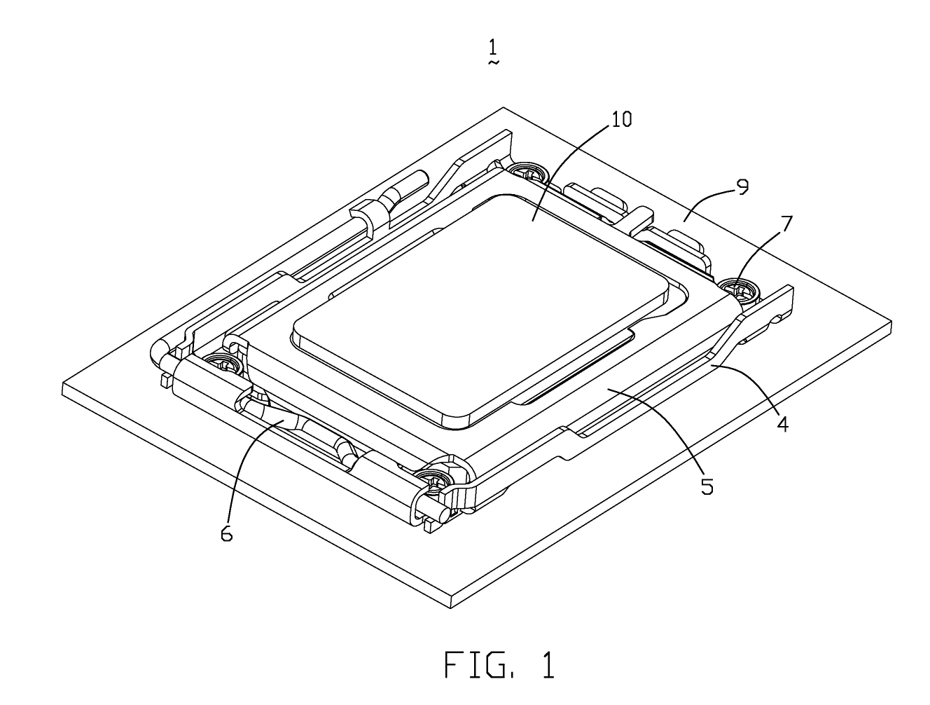

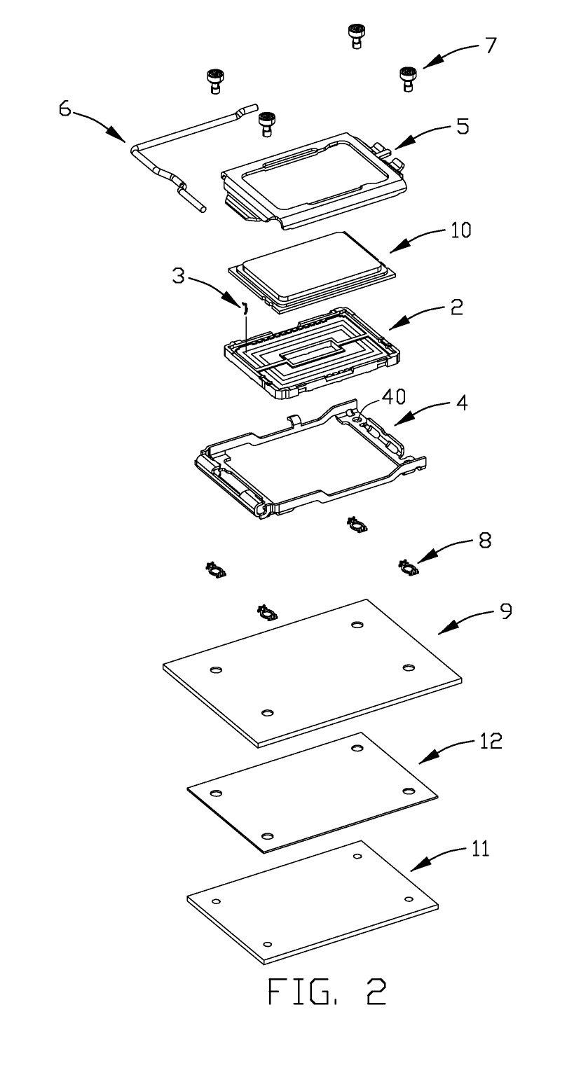

Referring to FIG. 1 and FIG. 2, an IC socket 1 made in accordance with a preferred embodiment of the present invention is mounted on a printed circuit board 9 for receiving an IC package 10. The IC socket 1 includes a socket body 2, a plurality of contact 3 received in the socket body 2, a stiffener plate 4 surrounding the socket body 2, and a load plate 5 and a load lever 6 pivotally coupled to opposite ends of the stiffener plate 4. The load plate 5 is able to load the IC package 10 into the socket body 2 to make electrical connection with the contacts 3. The load lever 6 locks the load plate 5 into a closed position. In an alternative embodiment, the IC package 10 should be directly secured into the socket body 2 by a heat sink (not shown) without employing the load plate 5 and the load lever 6.

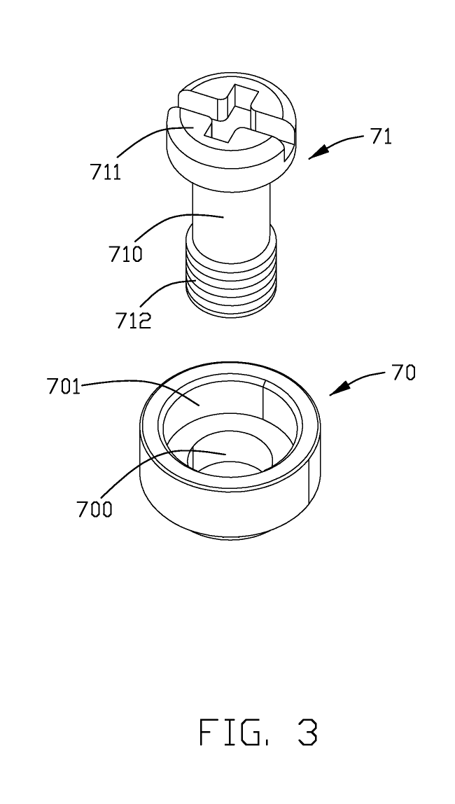

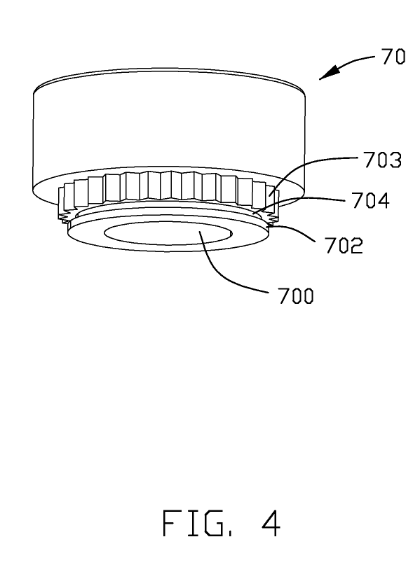

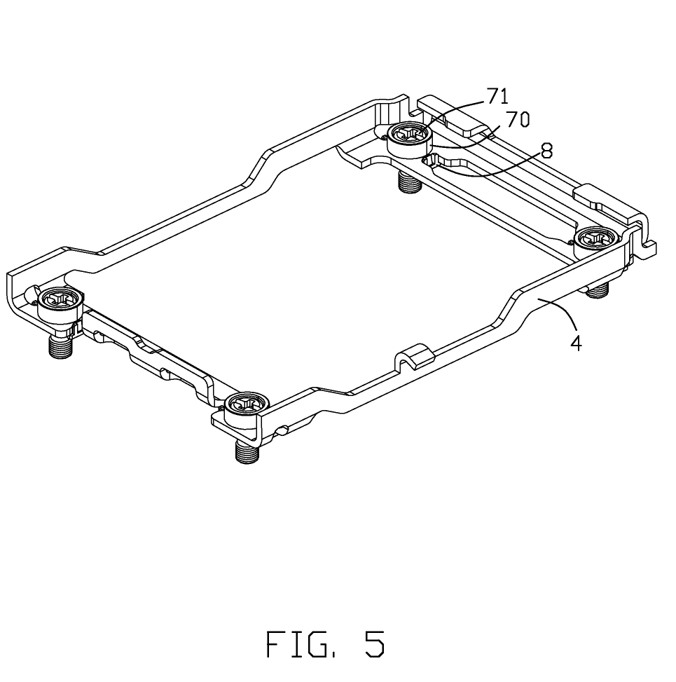

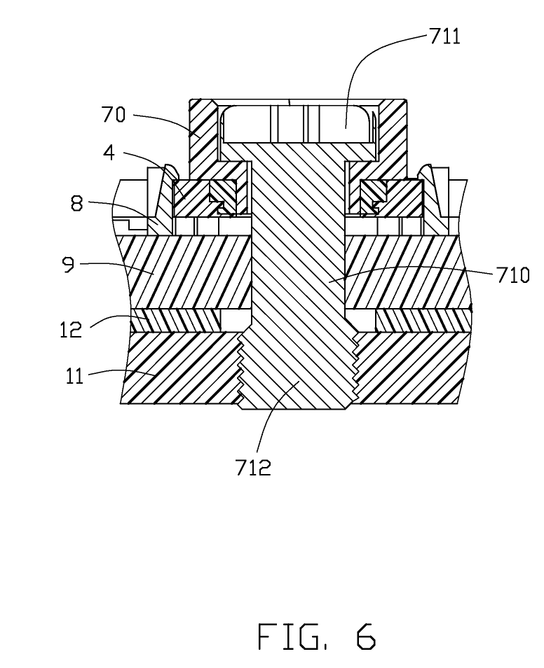

Referring to FIG. 2 to FIG. 6, the stiffener plate 4 is made of metal with a frame structure, and surrounds the socket body 2 to reinforce the socket body 2. There are four mounting holes 40 respectively located at each corner of the stiffener plate 4 to combine a locking arrangement 7 which is used for fixing the stiffener plate 4 onto the printed circuit board 9. A gasket 8 is positioned under the mounting hole 40 and upwardly bended to clip the stiffener plate 4. The locking arrangement 7 includes a ferrule 70 riveted within the mounting hole 40 and a screw 71 inseparably mounted within the ferrule 70. The ferrule 70 includes a through hole 700 and a cavity 701 above the through hole 700 and communicating with the through hole 700. The cavity 701 has a bigger diameter than that of the through hole 700. A guiding portion 702 and a riveting portion 703 are formed at a tip end of the ferrule 70, and jointly define a containing groove 704 therebetween. The guiding portion 702 has a smaller diameter than that of the mounting hole 40 of the stiffener plate 4 so as to provide guidance for inserting the ferrule 70 into the mounting hole 40. The riveting portion 703 interferes tightly with the mounting hole 40 to fix the ferrule 70 onto the stiffener plate 4. The containing groove 704 could be used for receiving metal scrap detached from the riveting portion 703 during the riveting process. The screw 71 includes a cylindrical neck portion 710, a head portion 711 above the neck portion and a locking portion 712 under the neck portion 710. Then the neck portion 712 is formed with screw thread thereon after it passes through the through hole 700, and the formed neck portion 712 has a bigger diameter than that of the through hole 700 so that the screw 71 can not escape away from the ferrule 70.

When the locking arrangement 7 is assembled to the stiffener plate 4, the screw 71 is firstly combined into the ferrule 70, and then the ferrule 70 is riveted within the mounting hole 40 and thereby immovably fixed on stiffener plate 4. The ferrule 70 also works as a constraining means for the screw 71, whereby the screw 71 is able to achieve a better assembling performance. Due to the combination therebetween, the locking arrangement 7 and the stiffener plate 4 could be simultaneously shipped and then mounted onto the printed circuit board 9, and thus the mounting efficiency is improved. The locking portion 712 of the screw 71 is finally locked into a back plate 11 under the printed circuit board 9. In addition, a dielectric plate 12 is provided between the printed circuit board 9 and the back plate 12.

Alternatively, in another preferred embodiment, the ferrule of the present invention should be combined with the stiffener plate via soldering means or other means instead of the riveting method.

Although the present invention has been described with reference to particular embodiments, it is not to be construed as being limited thereto. Various alterations and modifications can be made to the embodiments without in any way departing from the scope or spirit of the present invention as defined in the appended claims.

What is claimed is:

1. An IC socket mounted on a printed circuit board for receiving an IC package comprising:
a socket body;
a plurality of contacts received in the socket body;
a stiffener plate surrounding the socket body; and
a locking arrangement securing the stiffener plate to the printed circuit board, and comprising a ferrule fixed on the stiffener plate and a screw disposed within the ferrule before the stiffener plate is mounted onto the printed circuit board.

2. The IC socket as claimed in claim 1, wherein the stiffener plate is made of metal and defines a mounting hole, and the ferrule has a riveting portion engaging with the mounting hole via a riveting process.

3. The IC socket as claimed in claim 2, wherein the ferrule has a guiding portion formed at a tip end thereof with a diameter smaller than that of the mounting hole.

4. The IC socket as claimed in claim 3, wherein the guiding portion and the riveting portion together define a containing groove therebetween for receiving metal scrap detached from the riveting portion during the riveting process.

5. The IC socket as claimed in claim 1, further comprising a gasket positioned under the mounting hole and upwardly bended to clip the stiffener plate.

6. The IC socket as claimed in claim 5, wherein the ferrule defines a through hole and the screw has a neck portion and a head portion above the neck portion, the necking passing through the through hole.

7. The IC socket as claimed in claim 6, wherein the ferrule further has a cavity above the through hole for receiving the head portion of the screw, the cavity communicating with the through hole and having a bigger diameter than that of the through hole.

8. The IC socket as claimed in claim 6, wherein the screw further has a locking portion configured with screw thread thereon for engaging with a back plate under the printed circuit board.

9. The IC socket as claimed in claim 8, wherein the locking portion of the screw has a bigger diameter than that of the through hole of the ferrule so that the screw is not able to escape away from ferrule.

10. The IC socket as claimed in claim 1, wherein said screw is configured with larger dimensions on both ends so as to being constantly associated with said ferrule without possibility of withdrawal therefrom, either upwardly or downwardly.

11. A method of making an IC socket comprising the steps of:
providing a socket body holding a plurality of contacts therein;
providing a stiffener plate surrounding the socket body, the stiffener plate defining a mounting hole;
providing a ferrule configured with a through hole therein and a screw including a head portion and a cylindrical neck portion;
inserting the neck portion of the screw through the through hole of the ferrule and then forming screw thread on a tip end of the neck portion to produce a locking portion which is not able to pass through the through hole of the ferrule due to the screw thread; and
securely fixing the ferrule within mounting hole of the stiffener plate.

12. The method as claimed in claim 11, wherein the stiffener plate is made of metal, and the ferrule has a riveting portion, by which the ferrule is riveted within the mounting hole.

13. The method as claimed in claim 12, wherein the ferrule has a guiding portion formed at a tip end thereof with a diameter smaller than that of the mounting hole.

14. The method as claimed in claim 13, wherein the guiding portion and the riveting portion together define a containing groove therebetween for receiving metal scrap detached from the riveting portion during the riveting process.

15. The method as claimed in claim 10, wherein the ferrule further has a cavity above the through hole for receiving the head portion of the screw, the cavity communicating with the through hole and having a bigger diameter than that of the through hole.

16. The method as claimed in claim 15, further providing a back plate under the printed circuit board, the locking portion engaging the back plate.

17. An electrical connector assembly for use with an electronic package, comprising:
a metallic stiffener plate having a plate defining a center opening and a plurality of through holes in a periphery region surrounding said center opening;
an insulative housing disposed in the center opening; and
a plurality of locking devices each including a metallic ferrule extending into the corresponding through hole; wherein
the screw defines a head at a top end region and a screw section at a bottom end region opposite to the head, and said screw section defines an outer diameter being larger than an inner diameter of the ferrule after deformation of the ferrule is performed for preventing backward withdrawal of the screw from the corresponding ferrule prior to mounting the stiffener to a printed circuit board via said locking devices.

18. The electrical connector assembly as claimed in claim 17, wherein said deformation occurs during riveting said ferrule to the stiffener plate.

19. The electrical connector assembly as claimed in claim 18, wherein said ferrule defines an enlarged head portion seated upon an upper face of the stiffener plate and equipped with a recess to receive said head of the screw therein for restraining downward movement of the screw.

20. The electrical connector assembly as claimed in claim 19, further including a gasket attached upon a bottom face of the stiffener opposite to said head portion of the ferrule and seated upon the printed circuit board.
